(19) United States
(12) Patent Application Publication
(10) Pub. No.: US 2002/0164974 A1
(43) Pub. Date: Nov. 7, 2002

(54) Method and system for delivering an audio announcement in a telecommunications system

(75) Inventors: Wai Ming Hercule Kwan, Austin, TX (US); Margarita R. Ash, Leander, TX (US); Holger Steinbach, Round Rock, TX (US); James S. Umstetter, Taylor, TX (US)

Correspondence Address: Siemens Corporation, Attn: Elsa Keller, Legal Administrator, Intellectual Property Department, 186 Wood Avenue South, Iselin, NJ, 08830, US

(73) Assignee: SIEMENS INFORMATION AND COMMUNICATION PRODUCTS, LLC.

(21) Appl. No.: 09/849,569

(22) Filed: May 3, 2001

(51) Int. Cl. H04M 11/10

(52) U.S. Cl. 455/412; 455/413; 455/414; 455/417

(57) ABSTRACT

An incoming call (100) is received from a public switched telephone network (PSTN) (21) at a base unit (12). A caller id interface (26) extracts caller id information (27) from the incoming call. An answering machine handler (33) compares the caller id information with other caller id information stored in a directory (37). If a match is found between the caller id information and the other caller id information, then a voice announcement is communicated to one or more mobile units (14). The voice announcement is played instead of the second ring at the mobile units which have an enabled speaker (65).

### TECHNICAL FIELD OF THE INVENTION

This invention relates generally to the field of telecommunications and, more specifically, to a method and system for delivering an audio announcement in a telecommunications system.

### BACKGROUND OF THE INVENTION

As society grows more complex and operates at an ever accelerating pace, there has been a growing need for better and more flexible communication devices. One area that has experienced substantial development activity is the area of wireless communication. Wireless telephone systems are also known as portable, cordless or mobile telephone systems. A typical wireless communication system has a base station located at a customer's or user's premises. The base is connected to the Public Switched Telephone Network (PSTN) over a wireline interface and communicates with a mobile unit or handset over an air interface that permits the user to communicate remotely from the base station. While users desire the freedom and flexibility afforded by mobile wireless communications systems, they typically do not want to sacrifice the numerous features, such as caller id, that are available through the wireline service over the PSTN. In addition, users of wireless systems increasingly demand a voice quality that is as good as the voice quality available over a wireline link.

While wireless communication devices and methods have provided an improvement over prior approaches in terms of features, voice quality, cost, packaging size and weight, the challenges in the field of wireless telecommunications have continued to increase with demands for more and better techniques having greater flexibility and adaptability.

Therefore, a need has arisen for a new method and system for delivering an audio announcement in a telecommunications system.

### SUMMARY OF THE INVENTION

In accordance with the present invention, a method and system for delivering an audio announcement in a telecommunications system is provided that substantially eliminates or reduces disadvantages and problems associated with previously developed systems and methods.

A system for delivering an audio announcement in a telecommunication system is disclosed. The system comprises a base station coupled to a plain old telephone service (POTS) line and has a transceiver for communicating over an air interface. The system further comprises a mobile unit which is operable to communicate with the base station over the air interface and has a speaker. In addition, the system comprises a recorded message subsystem at the base station for recording a voice message and associating the voice message with first caller id information. Also, the system comprises circuitry at the base station for receiving second caller id information from the POTS and logic at the base station for selecting the voice message in response to the second caller id information and transmitting the voice message to the mobile unit. The system also comprises logic at the mobile unit for receiving the voice message and transmitting the voice message to the speaker.

A method for delivering an audio announcement in a telecommunication system is disclosed. The method comprises six steps. Step one calls for providing a recorded voice message associated with first caller id information. Step two calls for receiving second caller id information from a service provider. Step three calls for selecting the voice message in response to the second caller id information. Step four calls for transmitting the voice message from a base unit, connected to the service provider, to a mobile unit over an air interface. Step five calls for receiving the voice message at the mobile unit. The last step calls for playing the voice message over a speaker at the mobile unit.

A method for delivering an audio announcement in a telecommunication system is also disclosed. The method comprises eight steps. Step one calls for connecting a base station to a telecommunications service provider. Step two calls for recording a voice message at the base station. Step three calls for associating the voice message with a telephone number. Step four calls for receiving, at the base station, caller id information from a service provider. Step five calls for selecting the recorded voice message in response to the caller id information. Step six calls for selecting one of a plurality of mobile stations. Step seven calls for transmitting the voice message to the selected mobile station over an air interface. The last step calls for playing the voice message over a speaker at the mobile station.

A technical advantage of the present invention is the capability to associate an audio announcement with caller id information and announce the audio announcement in association with an incoming call. Another technical advantage of the present invention is the capability to make the audio announcement to multiple handsets using a connection-oriented protocol.

### BRIEF DESCRIPTION OF THE DRAWINGS

For a more complete understanding of the present invention, and for further features and advantages, reference is now made to the following description, taken in conjunction with the accompanying drawings, in which:

FIG. 1 is a block diagram illustrating a wireless telecommunication system including a base unit and a mobile unit constructed in accordance with the teachings of the present invention;

FIG. 2 is a flow diagram illustrating a method for providing an auditory caller id announcement using the system of FIG. 1; and

FIG. 3 is a flow chart illustrating a method for providing caller id voice announcement using the system of FIG. 1.

### DETAILED DESCRIPTION OF THE DRAWINGS

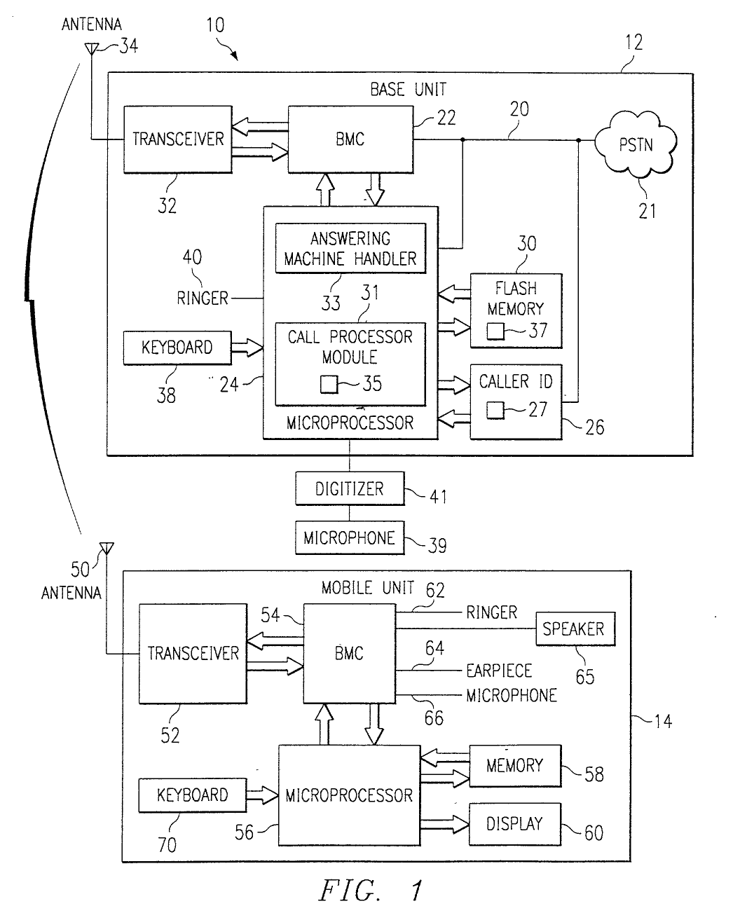

The preferred embodiment of the present invention and its advantages are best understood by referring to FIGS. 1 through 3 of the drawings, like numerals being used for like and corresponding parts of the various drawings.

FIG. 1 is a block diagram illustrating a telecommunication system 10 including a base unit 12 and one or more mobile units 14. The base unit 12 and the mobile unit 14 communicate with each other at a frequency in the industrial/scientific/medical (ISM) band. For example, the units 12 and 14 may communicate in the range of 2400 to 2483.5 MHz. It will be understood, however, that the base unit 12 and the mobile units 14 may communicate with each other at other suitable ISM-band frequencies without departing from the scope of the present invention.

The telecommunication system 10 illustrated in FIG. 1 is a wireless or cordless telephone system. In this exemplary embodiment, each mobile unit 14 comprises a mobile handset that communicates with the base unit 12 over discreet radio frequency channels. Although the telecommunication system 10 is illustrated as a cordless telephone system, it will be understood that the telecommunication system 10 may comprise any suitable type of wireless communication system. For example, the telecommunication system 10 may comprise a cellular telephone system, Local Multiple Distribution Service, and the like, without departing from the scope of the present invention.

In accordance with the exemplary embodiment shown in FIG. 1, the base unit 12 comprises a phone line 20 that is coupled to a Public Switched Telephone Network (PSTN) 21 over a landline for receiving and transmitting voice or other data. For an incoming telephone call, data from the phone line 20 is passed to a microprocessor 24 and a caller id interface 26. The caller id interface 26 extracts caller id information 27, such as a name and a telephone number associated with the originator of the telephone call, from the data on the phone line 20 and passes it to the microprocessor 24. The microprocessor 24 communicates with an internal flash memory 30 while processing the data received from the phone line 20 and the caller id interface 26. The microprocessor 24 also sends a signal to a ringer 40 to notify a user of an incoming call.

The microprocessor 24 then communicates the processed data from the phone line 20 and the caller id interface 26, along with any additional data that needs to be transmitted to the mobile units 14, to a burst mode controller (BMC) 22. The BMC 22 also receives data directly from the phone line 20, which is processed along with the data from the microprocessor 24. For example, the BMC 22 packages voice data from the phone line 20 with additional data from the microprocessor 24 into one frame structure. The BMC 22 also communicates the data to a transceiver 32 which transmits a signal through an antenna 34 to the mobile units 14.

Microprocessor 24 communicates with memory 30, BMC 22 and PSTN 21 under control of a call processor module 31. Call processor module 31 comprises a portion of microprocessor 24 and is operable to manage interactions and communication between memory 30, BMC 22 and PSTN 21. Call processor module 31 further comprises a caller id handler 35. Caller id hander 35 comprises a portion of module 31 which is operable to process caller id information 27 from interface 26.

Microprocessor 24 further comprises an answering machine handler 33. Answering machine handler 33 comprises a portion of microprocessor 24 operable to provide answering machine functionality to system 10. Specifically, answering machine handler 33 is operable to store a greeting and a plurality of messages in memory 30. The greeting comprises a voice message provided by a user (not shown) of system 10 to greet a caller when the user is unavailable. Each message comprises a voice message left by the caller to the user. Alternatively, the greeting and messages may incorporate a data portion for storing electronic data, such as for use with a pager, in the greeting and the messages.

Memory 30 also comprises a directory portion 37 for storing a plurality of voice announcements. Directory portion 37 comprises a portion of memory 30 in which a user (not shown) of system 10 may store one or more announcements to be made when particular caller id information 27 is received by microprocessor 24. The voice announcements comprise recorded announcements the user would like to hear when particular people, identified by caller id information, are calling, before the user answers the incoming call. In the disclosed embodiment, directory portion 37 associates one or more items of caller id information with an up to 2 second recorded message to be spoken when one of the associated items of caller id information is received with incoming call 100.

The base unit 12 also comprises a keyboard 38 for inputting data to the microprocessor 24. The keyboard 38 may comprise a numeric keypad for entering a telephone number or other data. The keyboard 38 may also comprise a pager button for paging the mobile units 14 such that the mobile units 14 provide a sound for locating the mobile units 14.

Base unit 12 further comprises a microphone 39 and a digitizer 41 for receiving and encoding the greeting to be used by answering machine handler 33. Microphone 39 comprises any suitable input device for receiving spoken audio input. Digitizer 41 comprises any suitable hardware and/or software for converting speech received by microphone 39 into an electrical form for use by microprocessor 24. In the disclosed embodiment, microphone 39 and digitizer 41 are used to obtain a voice announcement from the user.

Each mobile unit 14 respectively receives the signal from the base unit 12 through an antenna 50 which passes the data to a transceiver 52. The transceiver 52 processes the data and communicates the data to a BMC 54, which unpackages the data and communicates with a microprocessor 56. The microprocessor 56 communicates with an internal memory 58 and sends data to a display 60, such as an Liquid Crystal Display (LCD) or Light Emitting Diode (LED) based display. For example, the microprocessor 56 may send to the display 60 a name and a telephone number extracted by the caller id interface 26 in the base unit 12.

The BMC 54 also sends a signal to a ringer 62 to notify a user of an incoming call. After the user responds by activating the mobile unit 14, the BMC 54 sends the voice data received from the base unit 12 to an ear piece 64 and/or a speaker 65. Speaker 65 provides for hands-free use of mobile unit 14. Speaker 65 may be configured to be active or inactive by the user. After the connection is completed, voice data for transmission to the phone line 20 through the base unit 12 is received by the BMC 54 from the microphone 66 and/or speaker 65. This data is transmitted from the mobile unit 14 to the base unit 12 in a similar manner to the transmission of data from the phone line 20 to the ear piece 64 and speaker 65. If the user does not respond to the incoming call, answering machine handler 33 answers the incoming call, plays the greeting stored in flash memory 30 by the user and stores the message left by the caller in flash memory 30 for later access by the user.

The mobile unit 14 also comprises a keyboard 70 for a user to enter information for communication to the microprocessor 56. This keyboard 70 may be, for example, a numeric keypad on a mobile telephone handset for entering a telephone number.

The same process is also used for an outgoing telephone call, beginning with the activation of the mobile unit 14, which sends a signal through the BMC 54 to the transceiver 52 and from the transceiver 52 to the antenna 50. From the antenna 50 of the mobile unit 14 the signal is transmitted to the antenna 34 of the base unit 12, which passes the signal to the transceiver 32. The transceiver 32 passes the signal through the BMC 22 to the phone line 20. The telephone number being called, caller id information 27, voice data and other data is then communicated back and forth between the mobile unit 14 and the base unit 12 as previously described.

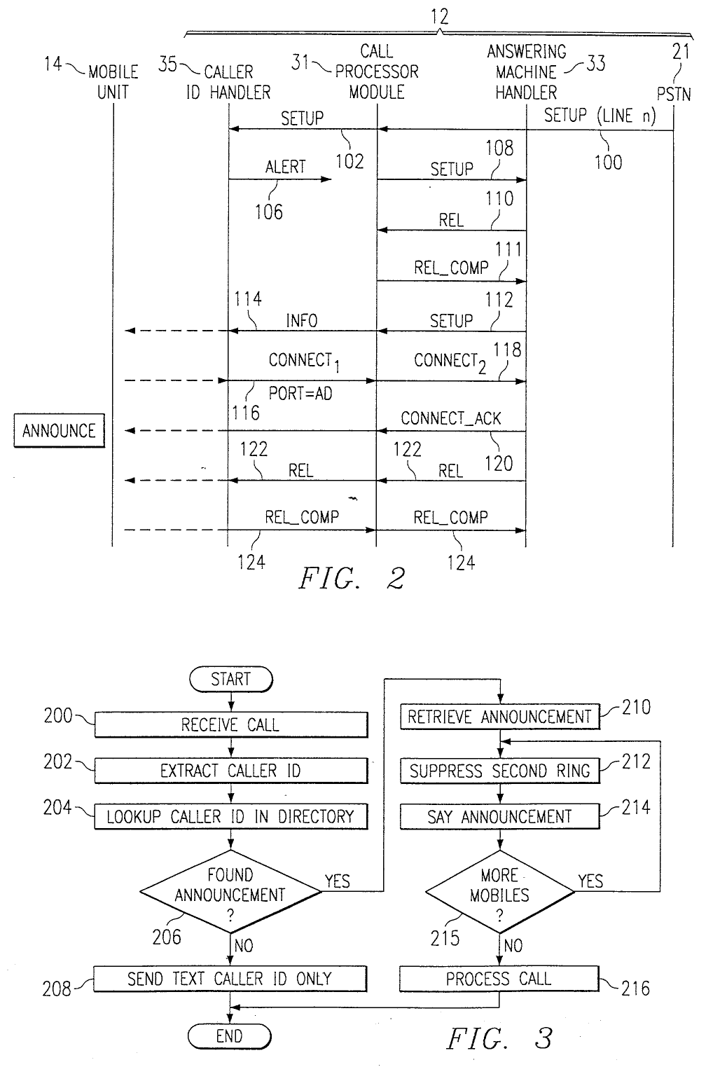

FIG. 2 illustrates a flow diagram illustrating a method for providing an auditory caller id announcement. An incoming call 100 is received over PSTN 21 and is received by call processor module 31. Caller id interface 26 analyzes incoming call 100 to determine whether caller id information 27 has arrived with incoming call 100 and passes that determination onto call processor module 31. If incoming call 100 has associated caller id information 27 then call processor module 31 dispatches a call setup message 102 to caller id handler 35. Call setup message 102 comprises an information element which includes caller id information 27. Caller id handler 35 receives setup message 102 and examines caller id information 27 in setup message 102. Once caller id handler 35 has determined that caller id information 27 is valid, then caller id handler 35 generates an alert 106. Caller id handler 35 then communicates alert 106 to call processor module 31. Alert 106 indicates that caller id handler 35 has verified caller id information 27.

Call processor module 31 then uses caller id information 27 to perform a voice announcement associated with caller id information 27. Call processor module 31 generates a setup message 108 to instruct answering machine handler 33 to perform a lookup using caller id information 27. Setup message 108 comprises an information element with caller id information 27 and a list of ports indicating which mobile units 14 to contact.

System 10 may include multiple mobile units 14 associated with a single base unit 12. In the disclosed embodiment, system 10 uses a connection-oriented protocol for supporting communication between base unit 12 and mobile unit 14. The connection-oriented protocol provides peer-to-peer communication between base unit 12 and mobile unit 14. The port list in setup message 108 indicates which mobile units 14 have enabled speakers 65 and should receive the voice announcement.

In response to message 108, answering machine handler 33 searches directory 37 in flash memory 30 for a match between caller id information 27 and previously stored caller id information. If answering machine handler 33 discovers matching caller id information to caller id information 27, then answering machine handler 33 stores the voice announcement message associated with the matched caller id information. Answering machine handler 33 then generates a release message 110. Release message 110 is communicated to call processor module 31 and indicates that answering machine handler 33 has completed doing a lookup on caller id information 27 and that call processor 31 may proceed with incoming call 100. Specifically, release message indicates whether or not a voice announcement has been matched to caller id information 27. Call processor module 31 then generates a release complete message 111. Release complete message 111 indicates that module 31 has received message 110 and is ready to perform voice announcement processing.

If a voice announcement has been matched to caller id information 27, then answering machine handler 33 generates a setup message 112. Setup message 112 comprises an information element with caller id information 27 and a list of ports indicating which mobile units 14 to contact. Setup message 112 indicates to call processor module 31 that a voice announce has been matched to caller id information 27 and is ready to be provided to the user through speaker 65 of one or more mobile units 14. The list of ports indicates which mobile units 14 have enabled speakers 65 and should receive the voice announcement.

Call processor module 31 examines setup message 112 and generates an information message 114 in response. Information message 114 is communicated to the mobile unit 14 indicated in setup message 112 and indicates to mobile unit 14 that base unit 12 has a voice announcement to be announced by mobile unit 14. In response to information message 114, mobile unit 14 generates a connect message 116.

Connect message 116 is then communicated back to base unit 12 and indicates to call processor module 31 that mobile unit 14 will accept the voice announce. Call processor module 31 then generates connect message 118 in response to connect message 116. Connect message 118 is communicated to answering machine handler 33 and indicates that answering machine handler 33 should provide the stored voice announcement to call processor 31 for communication to mobile unit 14. Answering machine handler 33 then generates a connection acknowledgement 120 in response to connect message 118. Connection acknowledgement 120 comprises the stored voice announcement to be communicated to mobile unit 14. Call processor module 31 receives connection acknowledgement 120 and communicates connection acknowledgement 120 to mobile unit 14 after performing any suitable processing.

The designated mobile unit 14 then plays the voice announcement using speaker 65. Answering machine handler 33 then generates a release message 122 which is communicated to call processor module 31. Release message 122 indicates that the answering machine handler 33 has finished providing the voice announcement and that call processor module can tear down the connection used to communicate the voice announcement to mobile unit 14. Release message is processed by module 31 and then communicated by call processor module 31 to mobile unit 14 to request connection tear down.

Mobile unit 14 generates release completion message 124 in response to message 122 which is communicated to call processor module 31. Release completion message 124 indicates that mobile unit 14 has successfully shut down or reallocated resources allocated to the connection for providing the voice announcement. Call processor module 31 then processes message 124 and communicates release completion message 124 to answering machine handler 33. Answering machine handler 33 then performs suitable shut down and clean up operations and the voice announcement connection is ended.

FIG. 3 is a flow chart illustrating a method for providing a caller id voice announcement to multiple mobile units 14. The method begins at step 200 where incoming call 100 is received from PSTN 21. Next, at step 202, caller id information 27 is extracted from incoming call 100 by interface 26. Next, at step 204, caller id information 27 is compared to caller id information stored in directory 35. Specifically, a lookup is made in directory 37 to find a match between the caller id information 27 and previously stored caller id information which is associated with a voice announcement. Proceeding to decisional step 206, caller id handler 35 determines whether a voice announcement associated with caller id information 27 has been found in directory 37. If no associated announcement is found, then the NO branch of decisional step 206 is followed to step 208. At step 208, a text-only caller id is communicated to mobile unit 14 and the method ends. If an associated announcement is found at step 206, then the YES branch of decisional step 206 is followed to step 210. At step 210, the matched announcement is retrieved from memory 30 and communicated to mobile unit 14.

Next, at step 212, call processor module 31 of base unit 12 instructs mobile unit 14 to suppress the second ring associated with incoming call 100. While the caller id information 27 associated with incoming call 100 is being processed by base unit 12, the first ring of the incoming call 100 has already sounded. The caller id lookup in step 204 and announcement retrieval in step 210 must be performed and completed before the end of the quiet period following the first ring. The voice announcement is then announced to the user instead of the second ring at step 214. In the disclosed embodiment, the voice announcement is announced over an intercom channel between base unit 12 and mobile unit 14.

Proceeding to decisional step 215, call processor module 31 examines the port list in message 112 to determine whether more mobile units 14 should be sent the voice announcement. If no further mobile units 14 are to receive the voice announcement, then the NO branch of decisional step 215 is followed to step 216. If further mobile units 14 are to receive the voice announcement, then the YES branch of step 215 is followed to step 212 where the second ring of the next mobile unit 14 on the port list is suppressed and messages 114, 116, 118 and 120, as describe in FIG. 2, are exchanged by the next mobile unit 14 and base unit 12. By suppressing the second ring of one or more mobile units 14, the voice announcement may be provided in a generally simultaneous manner. Then, at step 216, the call is processed normally and the method ends.

Although an embodiment of the invention and its advantages are described in detail, a person skilled in the art could make various alternations, additions, and omissions without departing from the spirit and scope of the present invention as defined by the appended claims.

What is claimed is:

1. A system for delivering an audio announcement in a telecommunication system, the system comprising:
a. a base station coupled to a plain old telephone service (POTS) line and having a transceiver for communicating over an air interface;
b. a mobile unit operable to communicate with the base station over the air interface and having a speaker;
c. a recorded message subsystem at the base station for recording a voice message and associating the voice message with first caller id information;
d. circuitry at the base station for receiving second caller id information from the POTS;
e. logic at the base station for selecting the voice message in response to the second caller id information and transmitting the voice message to the mobile unit; and
f. logic at the mobile unit for receiving the voice message and transmitting the voice message to the speaker.

2. The system of claim 1 further comprising a flash memory at the base station for recording the voice message.

3. The system of claim 1 further comprising a plurality of mobile units.

4. The system of claim 3 wherein logic at the base station selects which of the plurality of mobile units is to receive the voice message.

5. The system of claim 4 wherein the selection is based on which of the mobile units has an enabled speaker.

6. The system of claim 4 wherein logic at the base station provides the voice message to the selected mobile units generally simultaneously.

7. The system of claim 1 wherein logic at the base station selects one of the mobile units to receive the voice message.

8. The system of claim 1 wherein the first and second caller id information respectively comprise telephone numbers.

9. The system of claim 8 further comprising logic at the base station for determining which of the mobile units is speaker enabled.

10. The system of claim 1 wherein the logic compares the first and second caller id information to select the voice message.

11. The system of claim 1 wherein the logic at the base station communicates the voice message from the base station to the mobile unit using a connection-oriented protocol.

12. The system of claim 11 wherein the connection-oriented protocol uses a peer-to-peer communication technique.

13. The system of claim 1 wherein the first caller id information comprises a plurality of caller id information.

14. The system of claim 1 wherein the first caller id information comprises at least one telephone number.

15. The system of claim 1 wherein the first caller id information comprises at least one name.

16. A method for delivering an audio announcement in a telecommunication system, the method comprising:
a. providing a recorded voice message associated with first caller id information;
b. receiving second caller id information from a service provider;
c. selecting the voice message in response to the second caller id information;
d. transmitting the voice message from a base unit, connected to the service provider, to a mobile unit over an air interface;
e. receiving the voice message at the mobile unit; and
f. playing the voice message over a speaker at the mobile unit.

17. The method of claim 16 further comprising selecting one of a plurality of mobile units for receiving the voice message.

18. The method of claim 17 wherein the selection is based on which of the mobile units has an enabled speaker.

19. The method of claim 16 further comprising selecting at least one of a plurality of mobile units for receiving the voice message and wherein the voice message is received generally simultaneously at the selected mobile units.

20. The method of claim 16 wherein selecting the voice message comprises comparing the first and second caller id information and selecting the voice message based on the comparison.

21. The method of claim 20 further comprising transmitting the second caller id information in a text-only form when the first and second caller id information do not match.

22. The method of claim 16 wherein the mobile unit comprises a first mobile unit and further comprising transmitting the voice message from the base unit to a second mobile unit over the air interface.

23. The method of claim 16 further comprising determining which mobile units have enabled speakers.

24. The method of claim 16 wherein playing the voice message comprises suppressing a second ring associated with an incoming call and playing the voice message in place of the second ring.

25. The method of claim 16 wherein the voice message is transmitted from the base station to the mobile unit using a connection-oriented protocol.

26. The method of claim 25 wherein the connection-oriented protocol uses a peer-to-peer communication technique.

27. The method of claim 16 wherein the first caller id information comprises at least one telephone number.

28. The method of claim 16 wherein the first caller id information comprises at least one name.

29. A method for delivering an audio announcement in a telecommunication system, the method comprising:
a. connecting a base station to a telecommunications service provider;
b. recording a voice message at the base station;
c. associating the voice message with a telephone number;
d. receiving, at the base station, caller id information from a service provider;
e. selecting the recorded voice message in response to the caller id information;
f. selecting one of a plurality of mobile stations;
g. transmitting the voice message to the selected mobile station over an air interface; and
h. playing the voice message over a speaker at the mobile station.

30. The method of claim 29 wherein the connection between the base station and the telecommunications service provider is over a wire interface.

31. The method of claim 29 wherein the voice message is recorded in a memory at the base station.

32. The method of claim 29 wherein the caller id information is received between a first ring and second ring associated with an incoming call.

33. The method of claim 32 further comprising suppressing the second ring.

34. The method of claim 33, wherein the voice message is played over the speaker at the mobile station while the second ring is suppressed.

35. The method of claim 29 further comprising identifying which of the plurality of mobile stations has a speaker.

36. The method of claim 29 wherein selecting the recorded message comprises comparing the telephone number to the caller id information.

37. The method of claim 29 further comprising selecting one of a plurality of mobile stations for receiving the voice message.

38. The method of claim 37 wherein the selection is based on which of the mobile stations has an enabled speaker.

39. The method of claim 29 further comprising selecting at least one of a plurality of mobile stations for receiving the voice message and wherein the voice message is received generally simultaneously at the selected mobile stations.

40. The method of claim 29 the voice message is transmitted from the base station to the mobile station using a connection-oriented protocol.

41. The method of claim 40 wherein the connection-oriented protocol uses a peer-to-peer communication technique.

42. The method of claim 29 wherein the first caller id information comprises at least one telephone number.

43. The method of claim 29 wherein the first caller id information comprises at least one name.
